(19) United States
(12) Patent Application Publication
(10) Pub. No.: US 2025/0242561 A1
(43) Pub. Date: Jul. 31, 2025

(54) MOBILE AND PORTABLE COMPACTOR WITH FOLDABLE TROLLEY ARM

(71) Applicant: Sam Samad ATTISHA, La Mesa, CA (US)

(72) Inventor: Sam Samad ATTISHA, La Mesa, CA (US)

(21) Appl. No.: 19/036,196

(22) Filed: Jan. 24, 2025

Related U.S. Application Data
(60) Provisional application No. 63/626,344, filed on Jan. 29, 2024.

(51) Int. Cl. B30B 9/30

(52) U.S. Cl. CPC B30B 9/3042; B30B 9/3067

(57) ABSTRACT

A system includes a portable compactor having a vertical support, a horizontal support, and a trolley arm. The horizontal support and the trolley arm fold within an enclosure of the vertical support. The trolley arm folds within an enclosure of the horizontal support and includes a compactor ram that is driven to compact refuse.

### CROSS-REFERENCE TO RELATED APPLICATION

This application claims the benefit of U.S. Provisional Application No. 63/626,344 filed Jan. 29, 2024, entitled “Mobile & Portable Dumpster Refuse Compactor with Adjustable Hooking Mechanism and Foldable Trolley Arm,” the entire contents of which are incorporated herein by reference.

### BACKGROUND

There is a desire to maximize space in commercial dumpsters to assist in financial savings and waste removal fees. Additionally, maximizing space in a dumpster can reduce a number of trips that a refuse hauler has to make. Conventional solutions are very large, permanently attached, and are not mobile.

It is with these issues in mind, among others, that various aspects of the disclosure were conceived.

### SUMMARY

The present disclosure is directed to a portable compactor having a vertical support, a horizontal support, and a trolley arm. The horizontal support and the trolley arm fold within an enclosure of the vertical support. The trolley arm folds within an enclosure of the horizontal support and includes a compactor ram that is configured to move along a length of the horizontal arm to compact refuse.

In one example, the compactor system may have a wheeled dolly base to ensure smooth movement of the compactor system. Additionally, the compactor system may have a vertical support structure that may be attached to the dolly base. The compactor system may have integrated adjustable hooks to securely attach to a dumpster or refuse storage container. The compactor system may have a trolley arm having a folding mechanism that ensures the trolley arm can be easily folded out and securely locked. The trolley arm may have a compactor mechanism to compact refuse. The compactor mechanism may be configured to be folded into the vertical support structure.

The compactor mechanism may have a compactor ram that is included as part of the compactor mechanism. In addition, the compactor mechanism may have a worm drive and rack and pinion system to drive and operate the compactor mechanism.

In one example, a system may include a vertical support comprising a first vertical support beam and a second vertical support beam, the vertical support having a center receptacle within the first vertical support beam and the second vertical support beam to receive a horizontal support, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

In another example, a portable dumpster refuse compactor may include a vertical support comprising a first vertical support beam and a second vertical support beam, the vertical support having a center receptacle within the first vertical support beam and the second vertical support beam to receive a horizontal support, the vertical support including a hooking mechanism to securely attach the portable dumpster refuse compactor to a side of a refuse dumpster, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

In another example, a method may include moving a portable compactor to a desired location, the portable compactor including a vertical support comprising a first vertical support beam and a second vertical support beam, the vertical support having a center receptacle within the first vertical support beam and the second vertical support beam to receive a horizontal support, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support, wherein the trolley arm is configured to fold within the center receptacle of the horizontal support and the horizontal support is configured to fold within the center receptacle of the vertical support, unfolding the horizontal support of the portable compactor from the vertical support of the portable compactor, unlocking and unfolding the trolley arm from the horizontal support of the portable compactor, locking the trolley arm in a desired first position above the desired location, powering the trolley arm and operating the trolley arm using an input device of the portable compactor, and moving the compactor ram on an end of the trolley arm from the first position to a second position along the trolley arm to compact objects that come into contact with the compactor ram as the trolley arm moves from the first position to the second position at the desired location.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A is a block diagram of a compactor system according to an example of the instant disclosure.

FIG. 1B is another block diagram of the compactor system according to an example of the instant disclosure.

FIG. 2 is a computer-aided design (CAD) diagram of the compactor system according to an example of the instant disclosure.

FIG. 3 is another computer-aided design diagram of the compactor system according to an example of the instant disclosure.

FIG. 4 is another computer-aided design diagram of the compactor system according to an example of the instant disclosure.

FIG. 5 is another computer-aided design diagram of the compactor system according to an example of the instant disclosure.

FIG. 6 shows an example method of using the compactor system according to an example of the instant disclosure.

FIG. 7 shows another computer-aided design diagram of the compactor system according to an example of the instant disclosure.

FIG. 8 shows another computer-aided design diagram of the compactor system according to an example of the instant disclosure.

FIG. 9 illustrates another computer-aided design diagram of the compactor system according to an example of the instant disclosure.

FIG. 10 shows another computer-aided design diagram of the compactor system according to an example of the instant disclosure.

### DETAILED DESCRIPTION

The present disclosure is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present disclosure, as the disclosure encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms first, second, etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

In one example, a mobile and portable dumpster refuse compactor with an adjustable hooking mechanism and a foldable trolley arm, e.g., a compactor system, can maximize space in commercial dumpsters and help businesses save financial resources related to waste removal fees. Additionally, the compactor system can reduce the carbon footprint caused by too many trips by waste management.

Unfortunately, current and conventional compactors are large and already have an existing dumpster bin attached to them.

The compactor system may offer flexibility in its operation. In one example, the compactor system may have a compactor ram being drivable manually, hydraulically, pneumatically, or electronically or via battery operated drill. This versatility can accommodate various user preferences and operational requirements. The compactor system addresses the need for an efficient, portable, and adaptable dumpster refuse compactor. The compactor system also features attachable components for different uses.

The compactor system may maximize space in commercial dumpsters and assists businesses to save financial resources on waste removal fees.

The compactor system solves problems associated with conventional solutions via a mobile, mechanical, and mounted compactor that is designed for compacting dumpster refuse among other objects.

The compactor system may have a wheeled dolly base with a vertical support structure that may be equipped with adjustable hooks for secure attachment to any side of a refuse dumpster.

Unfortunately, conventional solutions are not mobile. The compactor system offers mobility such that an operator can wheel and relocate the compactor system from one location to another, providing ease of use.

In another example, the compactor system may be towed or mounted onto a vehicle such as a pickup truck, utilizing a bed of the vehicle and chassis via the hooking mechanism. The compactor system can be connected to the vehicle and maneuvered in different angles. This may allow someone to drive around to various job sites and easily connect the compactor system to a dumpster. The user may use the compactor system to compact refuse and drive the compactor system from one location to another location using a vehicle.

The compactor offers flexibility in its operation, with the compactor ram being drivable manually, hydraulically, pneumatically, or electronically. This versatility accommodates various user preferences and operational requirements. The compactor system addresses the need for an efficient, portable, and adaptable dumpster refuse compactor. The compactor system also features attachable components for different uses.

In one example, the compactor system can produce compostable products that may be recyclable.

The compactor system relates to a waste management device, specifically a portable or mounted compactor designed for compacting dumpster refuse. The compactor system may include foldable components for enhanced portability and ease of storage. In one example, the compactor system may feature a wheeled dolly base with a vertical support structure equipped with adjustable hooks for secure attachment to any side of a refuse dumpster. The hooking mechanism may be configured for dynamic repositioning along the dumpster wall, while effectively counteracting the compressor's downward force during operation.

In one example, contained within the vertical support is a horizontal trolley arm that can be folded out and securely locked into place, providing a compact form factor when not in use. The trolley arm may facilitate versatile movement along the length of the horizontal support, allowing for optimal positioning during the compaction process. The trolley arm may have a mechanism that incorporates a compactor ram actuated by a worm drive engaging a rack and pinion system. This may ensure precise and controlled compaction of dumpster refuse.

Furthermore, the compactor system provides flexibility in its operation, with the compactor ram being drivable manually, hydraulically, pneumatically, or electronically. This versatility accommodates various user preferences and operational requirements. As a result, the compactor system provides an efficient, portable, and adaptable dumpster refuse compactor.

The compactor mechanism may have one or more power sources such as manual power, hydraulic power, pneumatic power, and electronic power, among others.

The dumpster refuse compactor with the adjustable hooking mechanism and foldable trolley arm, with its versatile design and functionalities, could be adapted and repurposed for various applications in different fields.

As an example, the compactor system could be used for construction debris compaction. As an example, the compactor system could be used in construction sites to compact and manage construction debris efficiently. The adjustable hooks can be adapted to attach to different structures, and the compactor system may compact various types of construction waste.

As an example, the compactor system could be used for agricultural waste compaction. The adjustable hooking mechanism can be adapted to secure the compactor to farm equipment or storage containers, and the compaction process can help reduce the volume of agricultural residue.

As another example, the compactor system could be used at recycling centers. The compactor system may compact recyclable materials for easier transportation and processing. The device's portability and adjustable hooks can facilitate its use with different types of recycling containers.

As another example, the compactor system could be used for warehouse waste management. As an example, the compactor system may compact packaging materials and general waste. The adjustable hooking mechanism can be adapted to attach to different types of waste bins commonly found in warehouses.

As another example, the compactor system may be used for portable waste compaction for events. As an example, the compactor system could be used at events or outdoor gatherings to compact waste generated by attendees. The portable nature of the compactor system and its ability to attach to various containers make the compactor system suitable for temporary waste management solutions.

As another example, the compactor system may be used for medical waste disposal. The adjustable hooks can be adapted for secure attachment to medical waste bins, and the controlled compaction process ensures safe disposal of biohazardous materials.

As another example, the compactor system may be used in the mining industry. The compactor system may be used to compact and manage waste generated during mining operations. The portable design and adjustable hooks can be useful in different mining environments.

As another example, the compactor system may be used for disaster cleanup after disasters such as hurricanes, tornadoes, earthquakes, floods, and fires, among other disasters.

In one example, a user may use the compactor system by positioning the compactor in a particular location. In one example, the user may move or wheel the compactor to the desired location near a dumpster. The user may utilize the adjustable hooks on the vertical support structure to securely attach the compactor to any side of the refuse dumpster. Additionally, the user may dynamically reposition the hooks along the dumpster wall to ensure a secure and stable connection.

The user may unlock and unfold the horizontal trolley arm from its compact form and securely lock the trolley arm into place, providing a stable and extended platform for the compaction process.

The user may position the trolley arm to take advantage of the versatile movement along the length of the horizontal support to position the compactor optimally. Additionally, the user may ensure the compactor ram is aligned with an area in the dumpster having refuse to be compacted.

The user may choose an operation mode for the compactor system. Operation may be based on user preferences and operational requirements. Options may include manual, hydraulic, pneumatic, or electronic operation, among others.

If manual the user may operate the compactor ram manually using the designated controls. If hydraulic, pneumatic, or electronic the user may activate the chosen power source to engage the compactor ram. The user may monitor and control to ensure the compactor system is proceeding as desired and may use any provided controls or indicators to adjust compaction force or stop the process. Once the compaction is complete, the user may deactivate the compactor system and assess the compacted refuse.

Upon completion of compacting the refuse, the user may fold the trolley arm back into its compact form and securely lock the trolley arm into place and may move or wheel the compactor system to a storage location for enhanced portability.

The portable and adaptable features make the compactor system suitable for use in challenging environments and can create compostable product that could be recyclable.

Numerous businesses across various industries require effective trash management solutions to reduce space and costs. Some of these businesses include:

Retail Stores: Retail establishments generate a significant amount of packaging waste and cardboard, requiring efficient trash management to reduce space and disposal costs.

Restaurants and Food Service: Businesses in the food industry produce organic waste, food packaging, and other disposables, making waste compaction essential for optimizing space and managing waste disposal expenses.

Hotels and Hospitality: Hospitality businesses deal with a diverse range of waste, including food waste, packaging materials, and general refuse, making waste management solutions crucial for maintaining cleanliness and cost efficiency.

Manufacturing Facilities: Manufacturing plants often produce industrial waste and packaging materials, necessitating effective trash compaction to minimize waste volume and associated costs.

Office Buildings: Offices generate paper waste, packaging, and other recyclables, making waste management solutions beneficial for reducing space requirements and waste disposal expenses.

Residential Complexes: Waste management solutions are essential for apartment buildings and residential communities to efficiently handle household waste and optimize waste disposal costs.

As an example, a system may include a vertical support comprising a first vertical support beam and a second vertical support beam, the vertical support having a center receptacle within the first vertical support beam and the second vertical support beam to receive a horizontal support, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

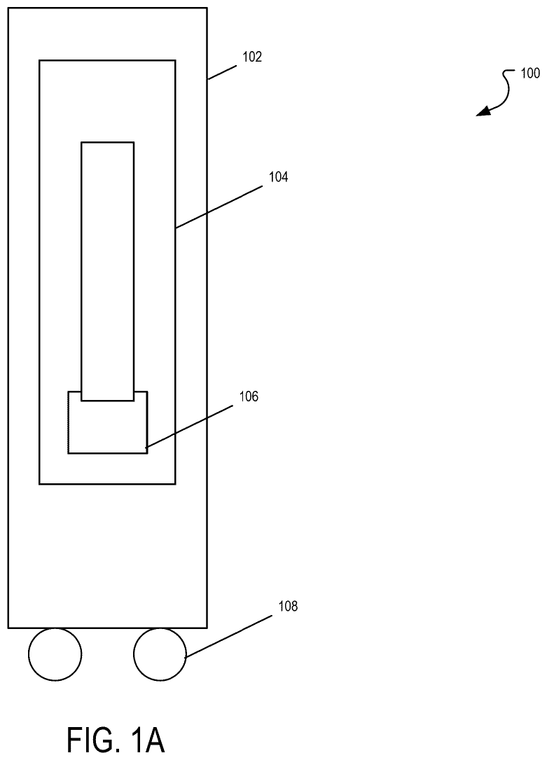

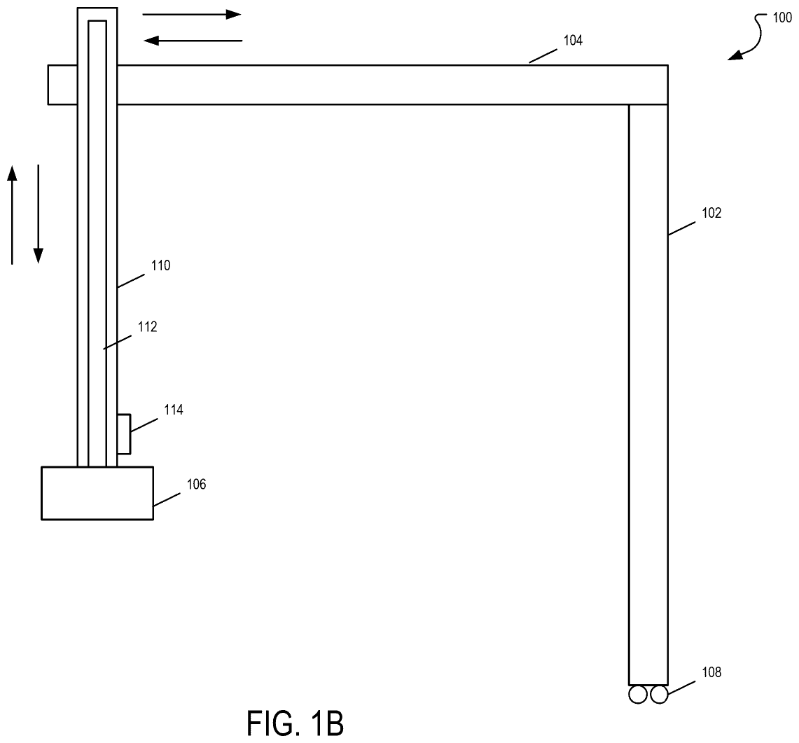

FIG. 1A is a block diagram of a mobile and portable dumpster refuse compactor with an adjustable hooking mechanism and a foldable trolley arm 100, also known as a compactor system, according to an example of the instant disclosure. FIG. 1A shows a block diagram of the compactor system 100 in a collapsed or folded position. In one example, the compactor system 100 may include a vertical support 102, a horizontal support 104, a trolley arm with a trolley assembly having a compactor ram 106, and a mobility system 108 that allows movement or transport of the compactor system 100.

In one example, the vertical support 102 may include a first vertical support beam and a second vertical support beam. In addition, the vertical support 102 may have a center receptacle within the first vertical support beam and the second vertical support beam to receive the horizontal support 104. The horizontal support 104 may include a first horizontal support beam and a second horizontal support beam. In addition, the horizontal support 104 may have a center receptacle within the first horizontal support beam and the second horizontal support beam to receive a trolley arm or assembly having the compactor 106. The trolley arm may rotate from within the center receptacle of the vertical support 102 up to ninety degrees such that the horizontal support 104 horizontally extends from a top of the vertical support 102.

In one example, the trolley arm may include the compactor ram 106 on one end of the trolley arm 110, a driving mechanism configured to supply power to the compactor ram 106, and a rack and pinion system connected to the driving mechanism. The trolley arm 110 may be configured to travel along the length of the horizontal arm 104 and the compactor ram 106 can be actuated by a worm drive engaging the rack and pinion system 112 to move from the top of the vertical support in a direction toward the bottom of the vertical support when the horizontal support horizontally extends from the top of the vertical support.

FIG. 1B is another block diagram of the compactor system 100 according to an example of the instant disclosure. As shown in FIG. 1B, the compactor system 100 is unfolded. The horizontal support 104 or arm is deployed and includes a trolley arm 110 or trolley assembly. The compactor ram 106 is moved by the worm drive engaged with the rack and pinion system 112. The compactor ram 106 may be configured to be driven by a driving mechanism 114.

As shown in FIG. 1B, the trolley arm 110 may travel along the length of the horizontal support 104 and the compactor ram 106 may be actuated by the worm drive engaging the rack and pinion system 112 to move from the top of the vertical support 102 in a direction toward the bottom of the vertical support 102 when the horizontal support 104 is unfolded and horizontally extends from the top of the vertical support 102. In one example, in operation and unfolded, the trolley arm may be parallel or nearly parallel to the vertical support 102 and perpendicular or nearly perpendicular to the horizontal arm 104. In one example, the trolley arm 110 may be unlocked from the horizontal support 104 and rotate downward away from the horizontal support 104 as in FIG. 1B. The trolley arm 110 also may rotated upward to be locked and secured within the center receptacle of the horizontal support 104 after use.

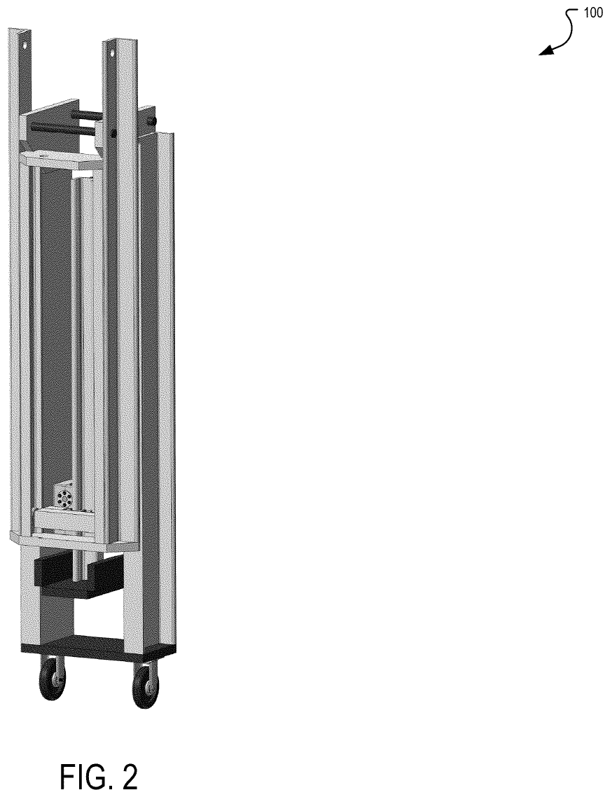

FIG. 2 is a computer-aided design diagram of the compactor system 100 according to an example of the instant disclosure. As shown in FIG. 2, the compactor system 100 comprises a mobile and portable dumpster refuse compactor with an adjustable hooking mechanism and a foldable trolley arm. FIG. 2 shows the mobile compactor 100 in a collapsed position according to an example of the instant disclosure.

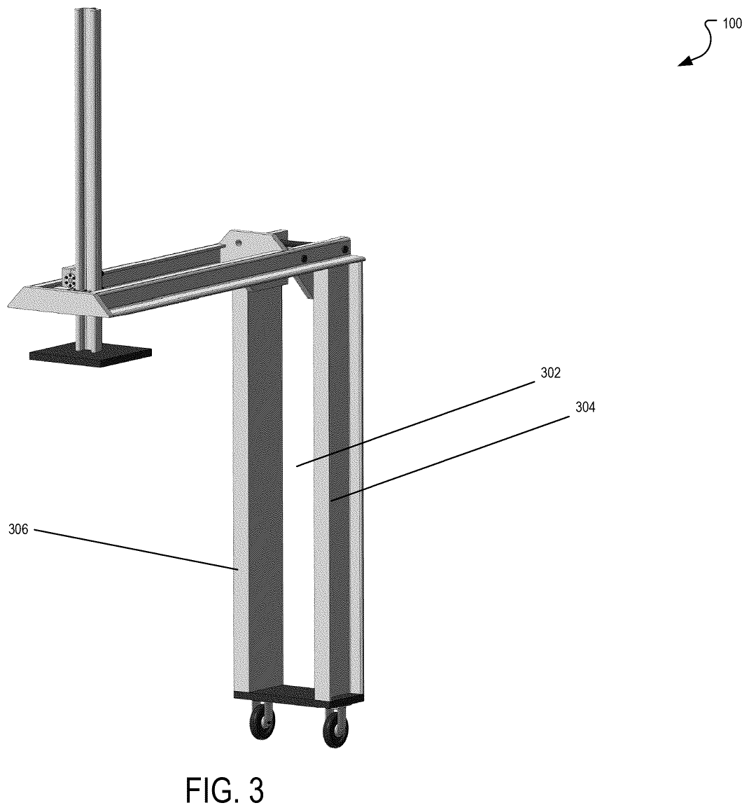

FIG. 3 is another computer-aided design diagram of the compactor system 100 according to an example of the instant disclosure. FIG. 3 shows the mobile compactor with the horizontal arm 104 unfolded and the compactor ram 106 deployed according to an example of the instant disclosure. FIG. 3 also shows a center receptacle 302 within a first vertical support beam 304 and a second vertical support beam 306 to receive the horizontal support 104.

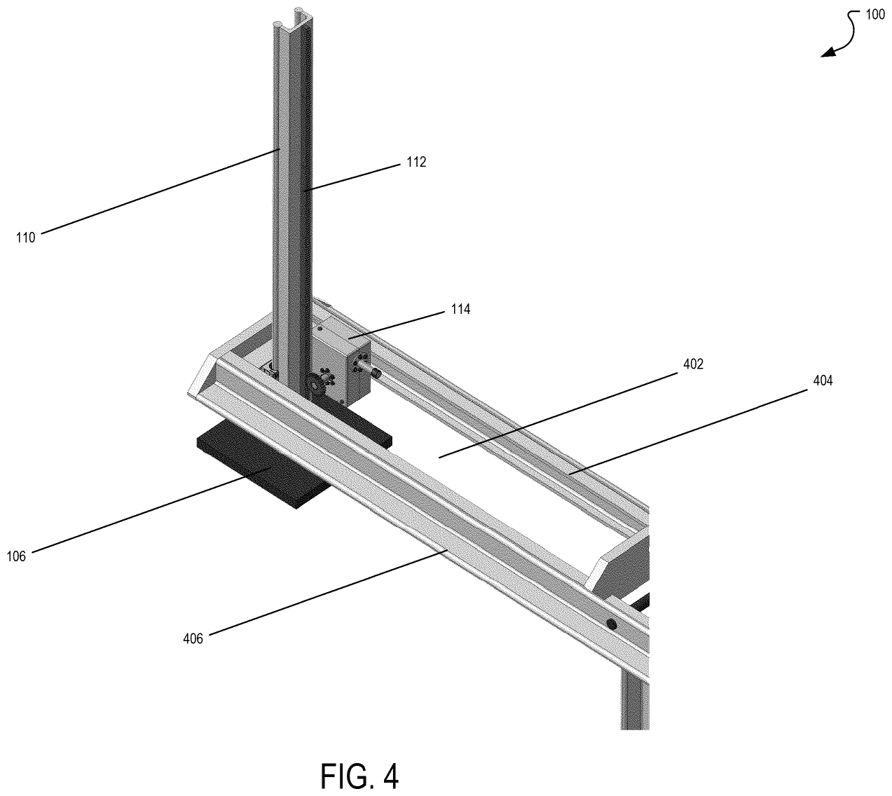

FIG. 4 is another computer-aided design diagram of the compactor system 100 according to an example of the instant disclosure. FIG. 4 shows the trolley arm 110 according to an example of the instant disclosure. FIG. 4 provides a detailed view of the trolley arm 110. In addition, FIG. 4 shows that the horizontal support 104 may have a center receptacle 402 within a first horizontal support beam 404 and a second horizontal support beam 406 to receive the trolley arm or assembly 110 having the compactor ram 106.

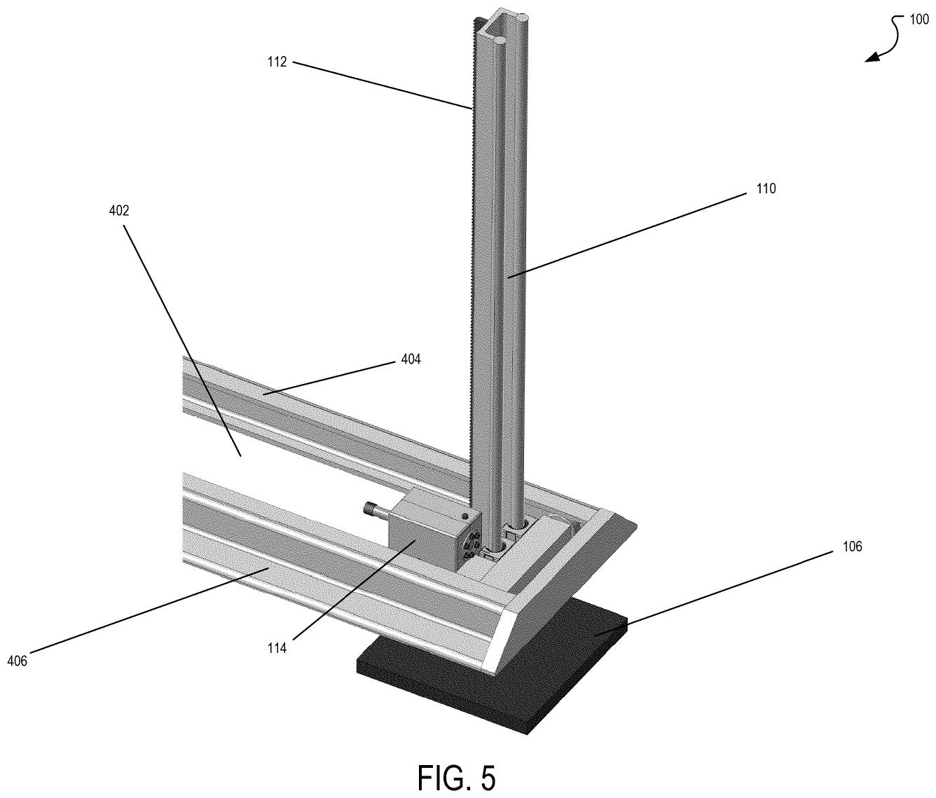

FIG. 5 is another computer-aided design diagram of the compactor system 100 according to an example of the instant disclosure. FIG. 5 shows another view of the trolley arm 110 according to an example of the instant disclosure.

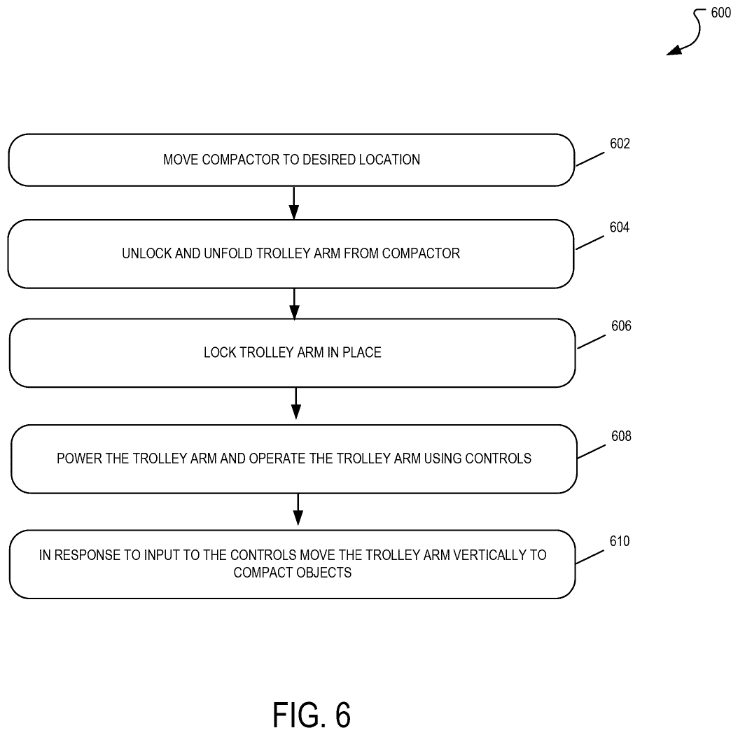

FIG. 6 shows an example method of using the portable compactor 100 according to an example of the instant disclosure. Although the example method 600 depicts a particular sequence of operations, the sequence may be altered without departing from the scope of the present disclosure. For example, some of the operations depicted may be performed in parallel or in a different sequence that does not materially affect the function of the method 600. In other examples, different components of an example device or system that implements the method 600 may perform functions at substantially the same time or in a specific sequence.

According to some examples, the method 600 may include moving the compactor system 100 to a desired location at block 602.

In one example, the compactor system 100 may include the vertical support 102 comprising a first vertical support beam 304 and a second vertical support beam 306, the vertical support having the center receptacle 302 within the first vertical support beam and the second vertical support beam to receive the horizontal support 104. Additionally, the horizontal support 104 may include the first horizontal support beam 404 and the second horizontal support beam 406. The horizontal support 104 may have the center receptacle 402 within the first horizontal support beam 404 and the second horizontal support beam 406 to receive the trolley arm 110 and configured to rotate from within the center receptacle 302 of the vertical support up 102 to ninety degrees such that the horizontal support 104 horizontally extends from a top of the vertical support 102.

In one example, the trolley arm 110 may include the compactor ram 106 on one end of the trolley arm and the driving mechanism 114 may be configured to supply power to the compactor ram 106. The rack and pinion system 112 may be connected to the driving mechanism 114. The trolley arm 110 can be configured to travel along a length of the horizontal support 104 and the compactor ram 106 can be actuated by a worm drive engaging the rack and pinion system 112 to move from the top of the vertical support 102 in a direction toward a bottom of the vertical support 102 when the horizontal support 104 horizontally extends from the top of the vertical support 102.

According to some examples, the method 600 may include unlocking and unfolding the trolley arm 110 from the compactor system 100 at block 604.

According to some examples, the method 600 may include locking the trolley arm 110 in place at block 606.

According to some examples, the method 600 may include powering the trolley arm and operating the trolley arm 110 using controls at block 608.

According to some examples, the method 600 may include moving the trolley arm to compact objects in response to the input to the controls at block 610.

According to some examples, the objects may be one of agricultural waste, recyclable materials, construction debris, medical waste, mining waste, and disaster waste.

According to some examples, the desired location may be one of a retail store, a restaurant or food service location, a hotel or hospitality location, a manufacturing facility, an office building, a residential location, and a healthcare facility.

In one example, the compactor system 100 may include a hooking structure to attach the vertical support structure 102 to a refuse dumpster. As an example, the hooking structure may include at least one hooking device.

In one example, the driving mechanism 114 may be at least one of a manual driving mechanism, a hydraulic driving mechanism, a pneumatic driving mechanism, and an electronic driving mechanism. Additionally, the driving mechanism 114 may include an input device to receive input to move the compactor ram 106.

In one example, the trolley arm 110 folds within the center receptacle of the horizontal support 104 and may include a scissor-type extension. As another example, the horizontal support 104 folds within the center receptacle 302 of the vertical support 102. Additionally, the vertical support 102 may include a base having at least one wheel 108.

As an example, the vertical support 102 includes a hooking mechanism to securely attach to a side and/or a bottom of a refuse dumpster. As another example, the hooking mechanism counteracts a force of the compactor ram 106 during operation.

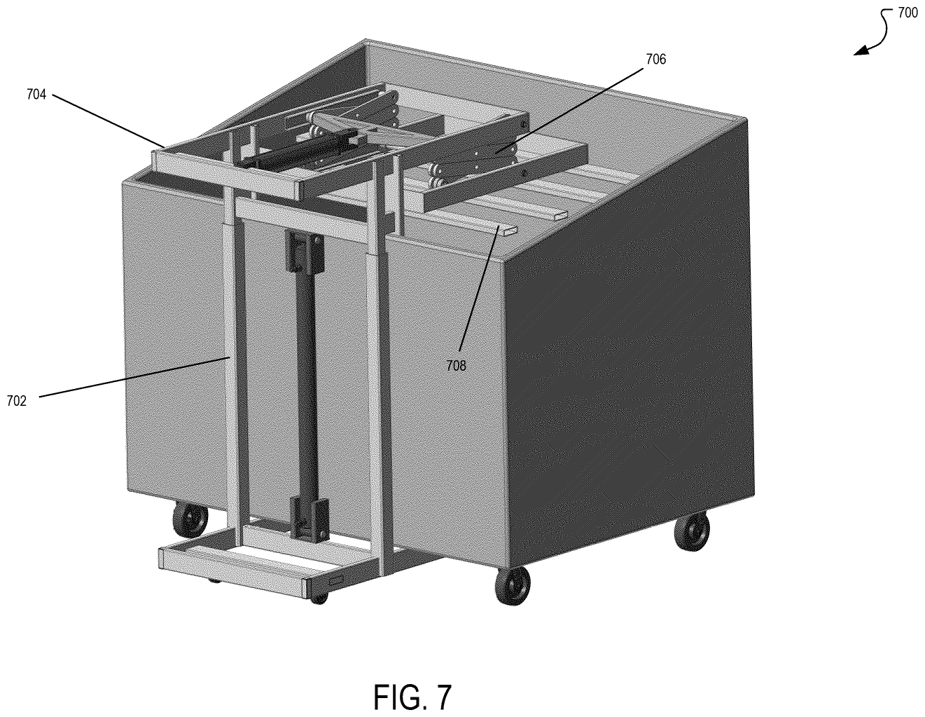

FIG. 7 shows another computer-aided design diagram of another embodiment of a compactor system 700 according to an example of the instant disclosure. As shown in FIG. 7, the compactor system 700 includes a vertical support 702, a horizontal support 704, and a trolley arm 706 having a compactor ram 708. The compactor ram 708 may have multiple arms or appendages that are attached to an end of the trolley arm 706. The compactor system 700 may include a vertical support 702 comprising a first vertical support beam and a second vertical support beam, the vertical support having a center receptacle within the first vertical support beam and the second vertical support beam to receive the horizontal support 704. The horizontal support may have an adjustable height based on a height of a dumpster or refuse container.

Additionally, the horizontal support 704 may include a first horizontal support beam and a second horizontal support beam. The horizontal support 704 may have a center receptacle within the first horizontal support beam and the second horizontal support beam to receive a trolley arm 706 and may be configured to rotate from within the center receptacle of the vertical support up 702 to ninety degrees such that the horizontal support 704 horizontally extends from a top of the vertical support 702. The trolley arm 706 may have a scissor-type of extension component that is connected to the horizontal support 704 on one end and to the compactor ram 708 on the other end. The compactor ram 708 may connect to the scissor-type extension component and have a base that is attached to one or more arms or appendages that extend along a length of the horizontal arm from one end to the other end of the horizontal arm when it is unfolded. As shown in FIG. 7, there may be one or more arms or appendages included on the compactor ram 708 to compact objects as they come into contact with the objects. FIG. 7 shows four appendages, but there may be more or less than four appendages.

As shown in FIG. 7, the compactor system 700 is located at a dumpster or refuse container to compact refuse in the dumpster or refuse container using the compactor ram 708 and the one or more appendages of the compactor ram 708.

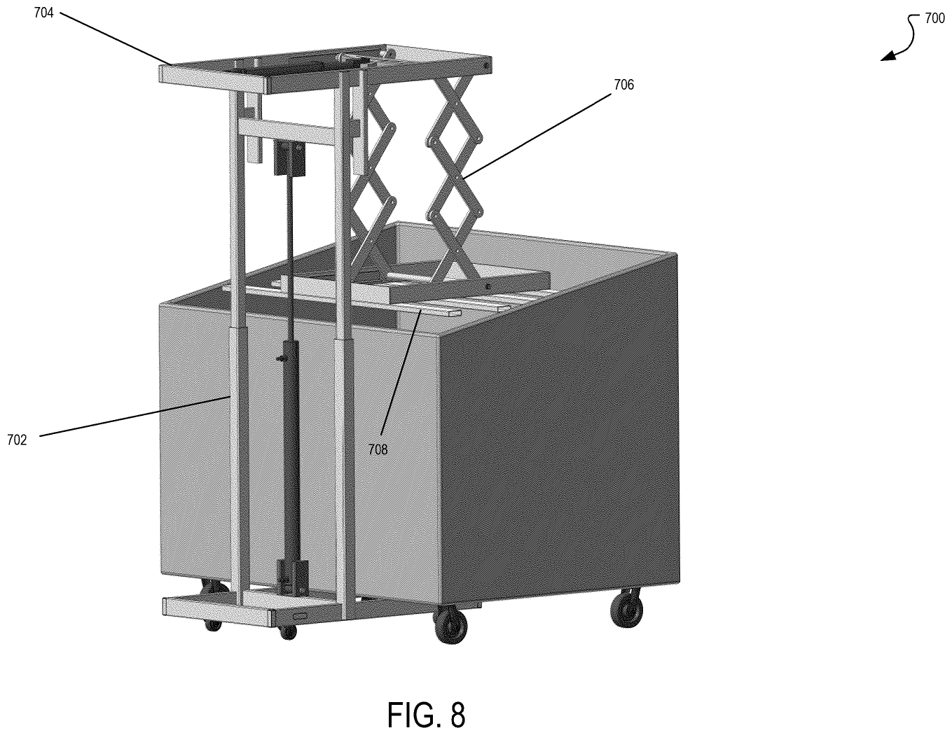

FIG. 8 shows another computer-aided design diagram of the another embodiment of the compactor system 700 according to an example of the instant disclosure. As shown in FIG. 8, the compactor system 700 is unfolded and in a position to compact the refuse in the dumpster or refuse container using the compactor ram 708.

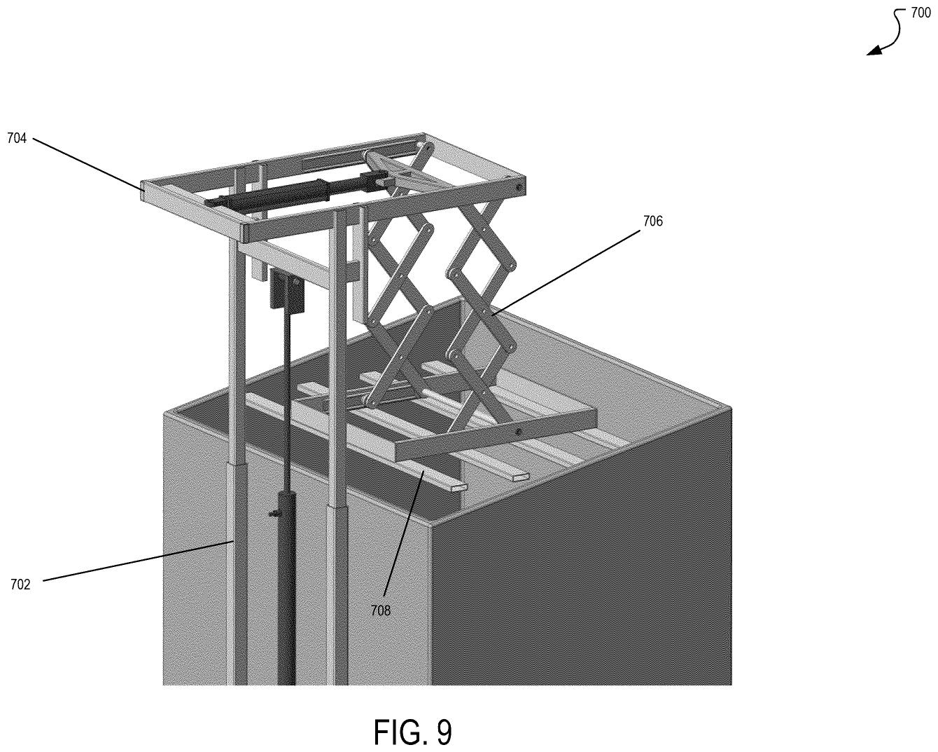

FIG. 9 illustrates another computer-aided design diagram of the another embodiment of the compactor system 700 according to an example of the instant disclosure. FIG. 9 shows a view of the compactor ram 708 and the compactor system 700 from the side and from above.

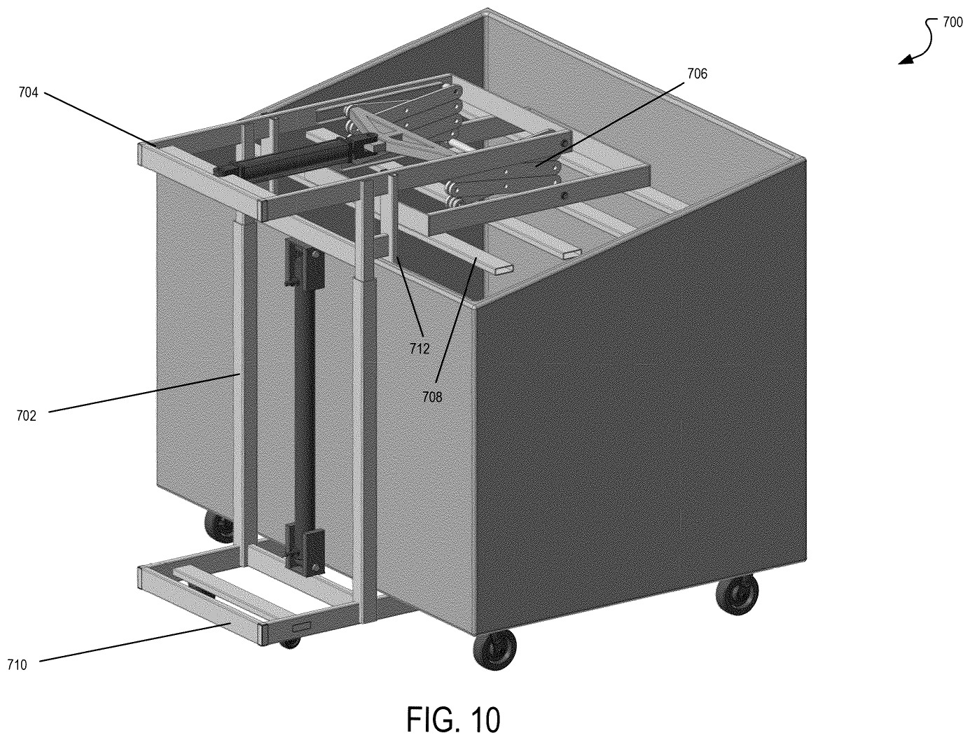

FIG. 10 shows another computer-aided design diagram of the another embodiment of the compactor system 700 according to an example of the instant disclosure. FIG. 10 shows a view of the compactor system 700 and the dumpster or refuse container from the side. As shown in FIG. 10, a base 710 of the compactor system 700 may be connected to the vertical support 702 and may be at least partially positioned under a bottom of the dumpster or refuse container. In addition, the compactor system 700 may have a hooking mechanism 712 to attach to a side of the dumpster or refuse container. In one example, the hooking mechanism 712 may be on an interior of the dumpster or refuse container and/or an exterior of the dumpster or refuse container.

The invention is not limited to the particular embodiments illustrated in the drawings and described above in detail. Those skilled in the art will recognize that other arrangements could be devised. The invention encompasses every possible combination of the various features of each embodiment disclosed. One or more of the elements described herein with respect to various embodiments can be implemented in a more separated or integrated manner than explicitly described, or even removed or rendered as inoperable in certain cases, as is useful in accordance with a particular application. While the invention has been described with reference to specific illustrative embodiments, modifications and variations of the invention may be constructed without departing from the spirit and scope of the invention as set forth in the following claims. Illustrative examples of the disclosure include:

Aspect 1: A system comprising: a vertical support comprising a first vertical support beam and a second vertical support beam, the vertical support having a center receptacle within the first vertical support beam and the second vertical support beam to receive a horizontal support, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

Aspect 2: The system of Aspect 1, further comprising a hooking structure to attach the vertical support to a refuse dumpster.

Aspect 3: The system of Aspects 1 and 2, wherein the hooking structure comprises at least one hooking device.

Aspect 4: The system of Aspects 1 to 3, wherein the driving mechanism comprises at least one of a manual driving mechanism, a hydraulic driving mechanism, a pneumatic driving mechanism, and an electronic driving mechanism.

Aspect 5: The system of Aspects 1 to 4, wherein the driving mechanism comprises an input device to receive input to move the compactor ram.

Aspect 6: The system of Aspects 1 to 5, wherein the trolley arm folds within the center receptacle of the horizontal support and comprises a scissor-type extension.

Aspect 7: The system of Aspects 1 to 6, wherein the horizontal support folds within the center receptacle of the vertical support.

Aspect 8: The system of Aspects 1 to 7, wherein vertical support comprises a base having at least one wheel.

Aspect 9: The system of Aspects 1 to 8, wherein the vertical support comprises a hooking mechanism to securely attach to a side of a refuse dumpster.

Aspect 10: The system of Aspects 1 to 9, wherein the hooking mechanism counteracts a force of the compactor ram during operation.

Aspect 11: A portable dumpster refuse compactor, comprising a vertical support comprising a first vertical support beam and a second vertical support beam, the vertical support having a center receptacle within the first vertical support beam and the second vertical support beam to receive a horizontal support, the vertical support including a hooking mechanism to securely attach the portable dumpster refuse compactor to a side of a refuse dumpster, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

Aspect 12: The portable dumpster refuse compactor of Aspect 11, further comprising a hooking structure to attach the vertical support to a refuse dumpster.

Aspect 13: The portable dumpster refuse compactor of Aspects 11 and 12, wherein the hooking structure comprises at least one hooking device.

Aspect 14: The portable dumpster refuse compactor of Aspects 11 to 13, wherein the driving mechanism comprises one of a manual driving mechanism, a hydraulic driving mechanism, a pneumatic driving mechanism, and an electronic driving mechanism.

Aspect 15: The portable dumpster refuse compactor of Aspects 11 to 14, wherein the driving mechanism comprises an input device to receive input to move the compactor ram.

Aspect 16: The portable dumpster refuse compactor of Aspects 11 to 15, wherein the trolley arm folds within the center receptacle of the horizontal support and comprises a scissor-type extension.

Aspect 17: The portable dumpster refuse compactor of Aspects 11 to 16, wherein the horizontal support folds within the center receptacle of the vertical support.

Aspect 18: A method, comprising moving a portable compactor to a desired location, the portable compactor comprising a vertical support comprising a first vertical support beam and a second vertical support beam, the vertical support having a center receptacle within the first vertical support beam and the second vertical support beam to receive a horizontal support, the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support, and the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support, wherein the trolley arm is configured to fold within the center receptacle of the horizontal support and the horizontal support is configured to fold within the center receptacle of the vertical support, unfolding the horizontal support of the portable compactor from the vertical support of the portable compactor, unlocking and unfolding the trolley arm from the horizontal support of the portable compactor, locking the trolley arm in a desired first position above the desired location, powering the trolley arm and operating the trolley arm using an input device of the portable compactor, and moving the compactor ram on an end of the trolley arm from the first position to a second position along the trolley arm to compact objects that come into contact with the compactor ram as the trolley arm moves from the first position to the second position at the desired location.

Aspect 19: The method of Aspect 18, wherein the objects comprise one of agricultural waste, recyclable materials, construction debris, medical waste, mining waste, and disaster waste.

Aspect 20: The method of Aspects 18 and 19, wherein the desired location comprises one of a retail store, a restaurant or food service location, a hotel or hospitality location, a manufacturing facility, an office building, a residential location, and a healthcare facility.

What is claimed is:

1. A system, comprising:
a vertical support comprising a first vertical support beam and a second vertical support beam, the vertical support having a center receptacle within the first vertical support beam and the second vertical support beam to receive a horizontal support;
the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support; and
the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

2. The system of claim 1, further comprising a hooking structure to attach the vertical support to a refuse dumpster.

3. The system of claim 2, wherein the hooking structure comprises at least one hooking device.

4. The system of claim 1, wherein the driving mechanism comprises at least one of a manual driving mechanism, a hydraulic driving mechanism, a pneumatic driving mechanism, and an electronic driving mechanism.

5. The system of claim 1, wherein the driving mechanism comprises an input device to receive input to move the compactor ram.

6. The system of claim 1, wherein the trolley arm folds within the center receptacle of the horizontal support and comprises a scissor-type extension.

7. The system of claim 6, wherein the horizontal support folds within the center receptacle of the vertical support.

8. The system of claim 1, wherein vertical support comprises a base having at least one wheel.

9. The system of claim 1, wherein the vertical support comprises a hooking mechanism to securely attach to a side of a refuse dumpster.

10. The system of claim 9, wherein the hooking mechanism counteracts a force of the compactor ram during operation.

11. A portable dumpster refuse compactor, comprising:
a vertical support comprising a first vertical support beam and a second vertical support beam, the vertical support having a center receptacle within the first vertical support beam and the second vertical support beam to receive a horizontal support, the vertical support including a hooking mechanism to securely attach the portable dumpster refuse compactor to a side of a refuse dumpster;
the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support; and
the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support.

12. The portable dumpster refuse compactor of claim 11, further comprising a hooking structure to attach the vertical support to a refuse dumpster.

13. The portable dumpster refuse compactor of claim 12, wherein the hooking structure comprises at least one hooking device.

14. The portable dumpster refuse compactor of claim 11, wherein the driving mechanism comprises one of a manual driving mechanism, a hydraulic driving mechanism, a pneumatic driving mechanism, and an electronic driving mechanism.

15. The portable dumpster refuse compactor of claim 11, wherein the driving mechanism comprises an input device to receive input to move the compactor ram.

16. The portable dumpster refuse compactor of claim 11, wherein the trolley arm folds within the center receptacle of the horizontal support and comprises a scissor-type extension.

17. The portable dumpster refuse compactor of claim 16, wherein the horizontal support folds within the center receptacle of the vertical support.

18. A method, comprising:
moving a portable compactor to a desired location, the portable compactor comprising:
a vertical support comprising a first vertical support beam and a second vertical support beam, the vertical support having a center receptacle within the first vertical support beam and the second vertical support beam to receive a horizontal support;
the horizontal support comprising a first horizontal support beam and a second horizontal support beam, the horizontal support having a center receptacle within the first horizontal support beam and the second horizontal support beam to receive a trolley arm and configured to rotate from within the center receptacle of the vertical support up to ninety degrees such that the horizontal support horizontally extends from a top of the vertical support; and
the trolley arm comprising a compactor ram on one end of the trolley arm, a driving mechanism configured to supply power to the compactor ram, and a rack and pinion system connected to the driving mechanism, the trolley arm configured to travel along a length of the horizontal support and the compactor ram actuated by a worm drive engaging the rack and pinion system to move from the top of the vertical support in a direction toward a bottom of the vertical support when the horizontal support horizontally extends from the top of the vertical support, wherein the trolley arm is configured to fold within the center receptacle of the horizontal support and the horizontal support is configured to fold within the center receptacle of the vertical support;
unfolding the horizontal support of the portable compactor from the vertical support of the portable compactor;
unlocking and unfolding the trolley arm from the horizontal support of the portable compactor;
locking the trolley arm in a desired first position above the desired location;
powering the trolley arm and operating the trolley arm using an input device of the portable compactor; and
moving the compactor ram on an end of the trolley arm from the first position to a second position along the trolley arm to compact objects that come into contact with the compactor ram as the trolley arm moves from the first position to the second position at the desired location.

19. The method of claim 18, wherein the objects comprise one of agricultural waste, recyclable materials, construction debris, medical waste, mining waste, and disaster waste.

20. The method of claim 18, wherein the desired location comprises one of a retail store, a restaurant or food service location, a hotel or hospitality location, a manufacturing facility, an office building, a residential location, and a healthcare facility.
